(19) United States
(12) Patent Application Publication
(10) Pub. No.: US 2008/0048885 A1
(43) Pub. Date: Feb. 28, 2008

(54) SYSTEM AND METHOD FOR PREDICTING PARKING SPOT AVAILABILITY

(76) Inventor: Joseph P. Quinn, Norfolk, MA (US)

Correspondence Address: Joseph P. Quinn, 17 Ridge Road, Norfolk, MA, 02056, US

(21) Appl. No.: 11/849,493

(22) Filed: Sep. 4, 2007

Related U.S. Application Data
(63) Continuation-in-part of application No. 11/501,406, filed on Aug. 9, 2006.
(60) Provisional application No. 60/843,693, filed on Sep. 11, 2006.

(51) Int. Cl. G08G 1/14

(52) U.S. Cl. 340/932.2; 340/933

(57) ABSTRACT

Embodiments of the present invention provide a system and method for maintaining a record of parking space usage data for a plurality of parking spaces, using the usage data to compute probability of availability for a given space as a function of time and communicating the resultant probability data along with availability data to an end user who is looking for a parking space in the area. This information can be combined with a user's estimated time of arrival (ETA) to assist the user in selecting a parking spot to drive to. A plurality of spaces can be ranked according to their likelihood of availability at an ETA to the general area or to each of the plurality of spaces.

### FIELD OF THE INVENTION

The present invention relates to the field of data processing and communication systems and more particularly to geographical information systems.

### BACKGROUND OF THE INVENTION

Various systems and methods have been developed for using electronic mapping technologies to provide driving directions, and to notify users of traffic conditions on major roadways and to estimate enroute times.

Various systems and methods have also been developed for using electronic navigation systems and communication systems to provide notification of available parking. For example, U.S. Pat. No. 6,927,700 to Joseph P. Quinn which is incorporated herein by reference in its entirety describes a system and method for automatically detecting vacant parking spaces and providing electronic street maps showing available spaces.

However, no heretofore known system or method can help motorists select a parking space which is most likely to be still available when a motorist arrives at the space.

### SUMMARY OF THE INVENTION

Embodiments of the present invention provide a system and method for maintaining a record of parking space usage data for a plurality of parking spaces, using the usage data to compute probability of availability for a given space as a function of time and communicating the resultant probability data along with availability data to an end user who is looking for a parking space in the area. This information can be combined with a user's estimated time of arrival (ETA) to assist the user in selecting a parking spot to drive to. A plurality of spaces can be ranked according to their likelihood of availability at an ETA to the general area or to each of the plurality of spaces.

An illustrative embodiment of the present invention provides a method for determining parking space availability by collecting data including times of occupancy and/or vacancy for at least one parking space over a representative period of time, calculating occupancy statistics for said at least one space as a function of said data, and using said occupancy statistics to calculate a probability of vacancy during a period of time corresponding to said representative period.

Period-specific data such as times of occupancy and/or vacancy can be collected for at least one parking space over a plurality of representative periods of time. Statistics can be calculated for each space as a function of said period-specific data. The statistics can be used, for example to calculate a probability of vacancy during a period of time corresponding to at least one of said representative periods of time. Such statistics can include, but are not limited to average time between occupancy and average duration of occupancy.

In an illustrative embodiment, the collected data is acquired by automatically sensing whether a vehicle is present or absent in a parking space to generate space occupancy/vacancy data and communicating said space occupancy/vacancy data to a database. The calculated probability data can then be communicated to a user and/or a user's vehicle.

The plurality of representative periods can be selected from the group consisting of: day, night, weekday, weeknight, weekend day, weekend night, days of the week, months of the year, winter, summer, in-season, off-season, during entertainment event, during weather event, and during school-year, for example.

In an illustrative embodiment, enhanced vacancy probability data can be provided to a vehicle by determining an estimated time of arrival of said vehicle at said space, determining the duration of a present occupancy or vacancy status of said space, computing the probability of vacancy of vacancy of said space at said estimated time of arrival according to said statistics and said duration, and communicating said probability of vacancy at said estimated time or arrival to said user.

The plurality of parking spaces can be ranked according to their likelihood of availability when said vehicle can be estimated to arrive at the respective spaces and according to the most quickly accessible spaces which have a high probability of vacancy upon arrival.

### BRIEF DESCRIPTION OF THE DRAWINGS

The foregoing and other features and advantages of the present invention will be more fully understood from the following detailed description of illustrative embodiments, taken in conjunction with the accompanying drawings in which:

FIG. 1 is a schematic block diagram of a system for providing statistically based parking availability predictions according to an illustrative embodiment of the present invention; and

FIG. 2 is process flow diagram of a method for determining parking space availability according to an illustrative embodiment of the present invention.

### DETAILED DESCRIPTION

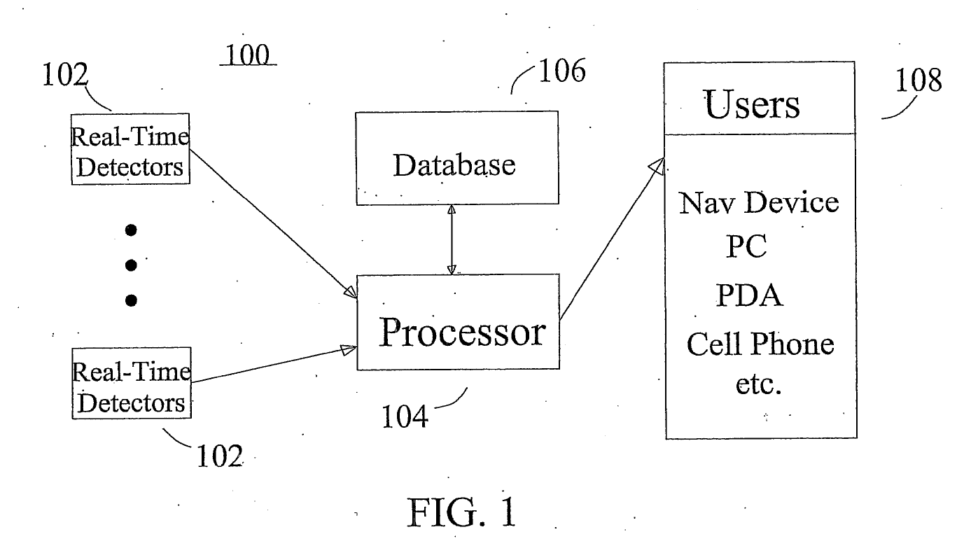

An illustrative system 100 for providing statistically based parking availability predictions is described in a schematic block diagram shown in FIG. 1. In the illustrative embodiment, real-time parking availability detectors such as those described in the U.S. Pat. No. 6,927,700, for example, detect the presence or absence of vehicles in a particular parking space or area. The real time detectors communicate parking availability data to a processor 104 which includes or communicates with a database 106. Although the present application is generally described with respect to real-time detectors such as sensors, various embodiments of the present invention can utilize virtually any type of communicating parking vacancy information and communicating it to a processor. For example, it is envisioned that parking lot operators may manually determine and manually report the number spaces available in a parking lot, or that the number of vehicles in the lot is indirectly determined by counting or detecting vehicles which arrive and/or depart from a given parking lot. Alternatively, the real-time detectors may be any type of sensor, including machine visions systems, which are capable of detecting the presence or absence of a vehicle in a lot or space.

The database 106, is used to accumulate data regarding various parking spaces and keep records of space attributes which, for example, track the times during which a given space or area was available or unavailable. Attributes such as, average time between vacancy and average duration of occupancy can be generated, stored and updated in the database. It envisioned that the availability statistics of particular spaces will vary depending on whether a time of interest is in a sub-period that corresponds to off-peak time, on-peak time, off-season, in-season, day, night, winter, summer, during an event etc.

Accordingly, in an illustrative embodiment of the invention, availability information for various spaces can be correlated with various sub periods and attributes can be generated, stored and provided as a function of various sub-periods. In illustrative embodiments, the attributes can be used to generate predictive statistics, such as probability of availability of a space at a particular time. The probability of availability may depend on the time that a particular space became vacant or occupied, so real-time data from a detector 102 can be combined with attributes, probability information or other statistical information, in the database 106 or processor 104, for example, to generate probabilities of vacancy at a particular time.

A probability of vacancy, thus generated, can be communicated from a processor or database, for example, to a user 108 such as a person enroute to a location where she will seek parking. The probability information can be provide in addition to or instead of real time vacancy information. The information can be provided by a variety transmission means and in a variety of format according to various embodiments of the invention. It is envisioned, that in at least one embodiment, information can be provided to a user by wireless communication to a receiving device for display on an electronic map, such as those provided in navigation systems, over the internet, and on some cell phones, personal digital assistants (PDAs), handheld computers, personal navigation devices or the like wherein a graphical indication of predicted space availability can be provided. Alternatively, the space vacancy probability information may be provided to a user via text messages or voice communication, for example.

Since certain computer programs and navigation systems can provide driving directions and calculate estimated times of arrival (ETA) at various locations, this information can be combined with the vacancy probability information to provide a time frame in which to predict probability of space vacancy near a destination location. Alternatively, a user may simply provide a specific time and area of interest so that an illustrative embodiment of the invention can provide statistical information or probability information to the user regarding the likelihood of parking space availability.

In an illustrative embodiment, a processor can compute, for a plurality of spaces near a user's selected destination, the user's ETA at particular spaces, determine the current availability status (vacant/occupied and optionally since what time) of the particular spaces, and the statistical attributes to predict availability at each and provide a ranking to the user of in order to assist the user to select an order of spaces in which to seek a vacancy. In various embodiments the ranking can be based solely on likelihood of availability at an ETA, or may include or weigh distance/travel time information into the ranking such that nearer spaces receive higher ranking for a given probability of availability, for example.

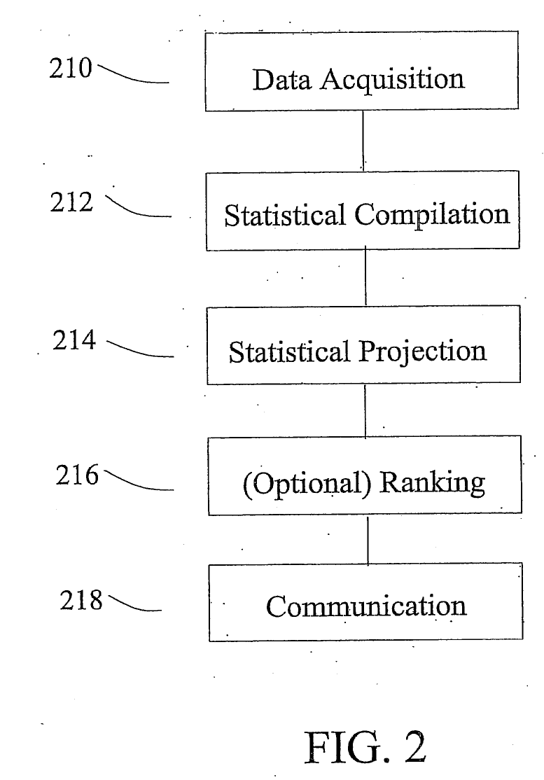

An illustrative embodiment of the invention is described with reference to the process flow diagram shown in FIG. 2. In a data acquisition step 210, information regarding vacancy of one or more parking space or parking area is collected, preferably in near real-time. The information can be collected from a variety of sources such as, automated sensors, parking vendors, or third party data providers, for example. In a statistics compilation step 212, statistics corresponding to parking space availability metrics are compiled for the parking spaces or areas. In a statistical projection step, 214 a likelihood of space availability at a user's estimated time of arrival can be predicted using the compiled statistics and/or real time information. In an optional ranking step 216, multiple spaces can be ranked by likelihood of availability at a user's ETA and/or most quickly reachable space with a particular, preferably high, likelihood of availability. In a communication step, availability probability information can be communicated to users. For example, it is envisioned that a user who may be access an electronic map for directions from a home PC before driving into a city may can receive information, preferably graphically displayed on the electronic map, which indicates available parking spaces and their corresponding probability of availabilities at a time of interest. Alternatively, a user who is enroute to an area where parking will be desired, may be able to access an electronic map or receive directions from any number of sources, such as, for example, a vehicle navigation system, a personal navigation system, a cell phone navigation program, a PDA navigation system, a subscription service such as On-Star, for example. In at least one embodiment, a user may receive verbal information regarding probability of space availability at a time of interest through a voice communication system, which a user may be able to receive telephonically through a wireless network, for example.

Although the present invention is described generally with reference to parking space availability information, persons having ordinary skill in the art should understand that various other embodiments of the present invention can provide other types of statistical information regarding other types of points of interest which are correlated to sub-periods that can be associated with a user's estimated time of arrival. For example, restaurant waiting times can be collected in a database for various restaurants, and predictive statistical information can be generated and provided to a user so that the user can be informed of the likelihood of finding an available table, or the likelihood of having to wait less than a predetermined number of minutes before being seated. In another illustrative embodiment, average waiting times in a cue, such at a toll both can be generated and provided to a user in the manner generally described herein before with respect to parking space information. In illustrative embodiments, this type of predictive statistical information relating to a particular time frame can be provided to a user through a variety of communication means, such as, for example, via a geographic information system, navigation system, cell phone network, internet or the like.

While the invention has been described with reference to illustrative embodiments, it will be understood by those skilled in the art that various other changes, omissions and/or additions may be made and substantial equivalents may be substituted for elements thereof without departing from the spirit and scope of the invention. In addition, many modifications may be made to adapt a particular situation or material to the teachings of the invention without departing from the scope thereof. Therefore, it is intended that the invention not be limited to the particular embodiment disclosed for carrying out this invention, but that the invention will include all embodiments falling within the scope of the appended claims. Moreover, unless specifically stated any use of the terms first, second, etc. do not denote any order or importance, but rather the terms first, second, etc. are used to distinguish one element from another.

1. A method for determining paring space availability comprising:
collecting data including times of occupancy and/or vacancy for at least one parking space over a representative period of time;
calculating occupancy statistics for said at least one space as a function of said data;
using said occupancy statistics to calculate a probability of vacancy during a period of time corresponding to said representative period.

2. The method according to claim 1 further comprising:
collecting period-specific data including times of occupancy and/or vacancy for at least one parking space over a plurality of representative periods of time;
calculating said statistics for each of said at least one space as a function of said period-specific data; and
using said occupancy statistics to calculate a prob ability of vacancy during a period of time corresponding to at least one of said representative periods of time.

3. The method according to claim 1 wherein said statistics include average time between occupancy and average duration of occupancy.

4. The method according to claim 1 wherein said collecting is performed by automatically sensing whether a vehicle is present or absent in a parking space to generate space occupancy/vacancy data and communicating said space occupancy/vacancy data to a database.

5. The method according to claim 2 wherein said plurality of representative periods are selected from the group consisting of: day, night, weekday, weeknight, weekend day, weekend night, winter, summer, in-season, off-season, during entertainment event, during weather event, and during school-year.

6. The method according to claim 2 wherein said plurality of representative periods correspond to days of the week and/or months of the year.

7. The method according to claim 1 further comprising: communicating said probability to a user.

8. The method according to claim 1 further comprising: communicating said probability to a user's vehicle.

9. The method according to claim 1 further comprising providing enhanced vacancy probability data to a vehicle by:
determining an estimated time of arrival of said vehicle at said space;
determining the duration of a present occupancy or vacancy status of said space;
computing the probability of vacancy of vacancy of said space at said estimated time of arrival according to said statistics and said duration; and
communicating said probability of vacancy at said estimated time or: arrival to said user.

10. The method according to claim 9 further comprising:
ranking a plurality of said parking spaces according to their likelihood of availability when said vehicle can be estimated to arrive at each of said plurality of parking spaces and according to the most quickly accessible space with a high probability of vacancy upon arrival.

11. A system comprising:
one to a plurality of detector stations capable of detecting vehicle presence in one or more locations;
a central processor in communication with said detector stations and in communication with a publicly accessible network;
wherein said central processor is programmed to maintain at least one database of said vehicle presence data received from said detector stations, and integrates said vehicle presence data with geographical map data, and further provides a data structure which comprises a graphical representation of said vehicle presence data with geographical data, said graphical representation being remotely accessible via said publicly accessible network.
